(19) United States
(12) Patent Application Publication
(10) Pub. No.: US 2023/0121483 A1
(43) Pub. Date: Apr. 20, 2023

(54) SYSTEMS AND METHODS FOR DETERMINING DRONE TRAFFIC PATTERNS

(71) Applicant: HERE GLOBAL B.V., Eindhoven (NL)

(72) Inventor: Leon Stenneth, Chicago, IL (US)

(73) Assignee: HERE GLOBAL B.V., Eindhoven (NL)

(21) Appl. No.: 17/505,190

(22) Filed: Oct. 19, 2021

(51) Int. Cl. G08G 5/00

(52) U.S. Cl. CPC G08G 5/0004

(57) ABSTRACT

Systems and methods for determining drone traffic patterns are provided. For example, a method for determining a drone traffic pattern includes analyzing drone activity of drones in an area. The analysis is based on a speed, heading, altitude, or a combination thereof, of the drones. The method also includes determining one or more drone traffic patterns based on the analysis. The method also includes encoding the determined one or more drone traffic patterns in a database to provide one or more instructions for operation of a drone in the area.

### TECHNICAL FIELD

The present disclosure relates generally to drone activity in an area, and more specifically to systems and methods for determining drone traffic patterns.

### BACKGROUND

Drone activities vary according to many factors such as drone availability, weather such as heavy wind (e.g., mountainous regions) in addition to population density in an area. One obstacle in managing a fleet of drones is the variability in drone activity in any given area. For example, this variability generally is not uniform across all locations and can vary across different terrains, locations, etc., thereby creating significant challenges for the service providers to overcome to deliver consistent services across these different locations.

### BRIEF SUMMARY

The present disclosure overcomes the shortcomings of prior technologies. In particular, a novel approach for determining drone traffic patterns is provided, as detailed below.

In accordance with an aspect of the disclosure, a method for determining a drone traffic pattern is provided. The method includes analyzing drone activity of drones in an area. The analysis is based on speed, heading, altitude, or a combination thereof, of the drones. The method also includes determining one or more drone traffic patterns based on the analysis. The method also includes encoding the determined one or more drone traffic patterns in a database to provide one or more instructions for operation of a drone in the area.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device to analyze drone activity of drones in an area. The analysis is based on speed, heading, altitude, or a combination thereof, of the drones. The one or more instructions further cause the device to determine one or more drone traffic patterns based on the analysis. The one or more instructions further cause the device to provide one or more instructions for operation of a drone in the area based on the determined one or more drone traffic patterns.

In accordance with another aspect of the disclosure, an apparatus is provided. The apparatus includes a processor. The apparatus also includes a memory comprising computer program code for one or more programs. The computer program code is configured to cause the processor of the apparatus to analyze drone activity of drones in an area. The analysis is based on speed, heading, altitude, or a combination thereof, of the drones. The computer program code is further configured to cause the processor of the apparatus to determine one or more drone traffic patterns based on the analysis. The computer program code is further configured to cause the processor of the apparatus to provide one or more instructions for utilization of the determined one or more drone traffic patterns.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of determining drone traffic patterns, in accordance with aspects of the present disclosure;

FIG. 2 is a diagram illustrating an example of drone activity, in accordance with aspects of the present disclosure;

FIG. 3 is a diagram illustrating an example of drone traffic patterns, in accordance with aspects of the present disclosure;

FIG. 4 is a graph illustrating an example of drone traffic patterns, in accordance with aspects of the present disclosure;

FIG. 5 is a graph illustrating another example of drone traffic patterns, in accordance with aspects of the present disclosure;

FIG. 6 is a diagram of a geographic database, in accordance with aspects of the present disclosure;

FIG. 7 is a diagram of the components of a data analysis system, in accordance with aspects of the present disclosure;

FIG. 8 is a flowchart setting forth steps of an example process, in accordance with aspects of the present disclosure;

FIG. 9 is a flowchart setting forth steps of another example process, in accordance with aspects of the present disclosure;

FIG. 10 is a flowchart setting forth steps of another example process, in accordance with aspects of the present disclosure;

FIG. 11 is a diagram of an example computer system, in accordance with aspects of the present disclosure;

FIG. 12 is a diagram of an example chip set, in accordance with aspects of the present disclosure; and

FIG. 13 is a diagram of an example mobile device, in accordance with aspects of the present disclosure.

### DESCRIPTION OF SOME EMBODIMENTS

Examples of a method, a non-transitory computer-readable storage medium, and an apparatus for determining drone traffic patterns are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

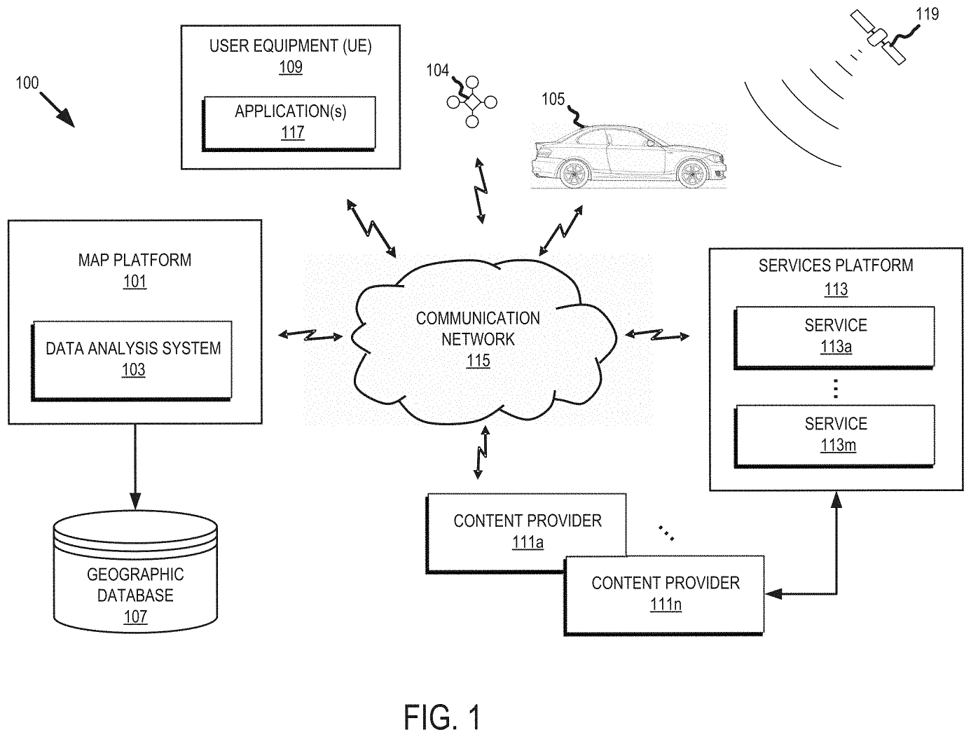

FIG. 1 is a diagram of a system 100 capable of determining drone traffic patterns, according to one embodiment. The system 100 of FIG. 1 introduces a capability to determine a drone traffic pattern based on the analysis of drone activity in an area. The analysis is based on aspects of drone operation such as the speed, heading, and altitude, or a combination thereof, in an area. In one embodiment, the drone traffic pattern is based on the average speed of the drones in the area. In another embodiment, the drone traffic pattern is based on the average heading of the drones in the area. In another embodiment, the drone traffic pattern is based on the average altitude of the drones in the area. The system 100 can encode the drone traffic patterns in a database to provide instructions for operating of a drone in the area. In one example, encoding the drone traffic patterns includes mapping the drone traffic patterns onto a map data layer.

In one embodiment, the drone traffic patterns provide a useful mechanism that the system 100 can use to adapt one or more services. In one example, a company that provides a service for monitoring an area via drones may utilize the drone traffic patterns for optimization of fleet management. In another example, a company that provides a service for delivering packages in an area via drones may utilize the drone traffic patterns for optimization of fleet management. Example use-cases of the drone traffic patterns include, but are not limited to: (1) automatically varying one or more of drone speed, drone altitude, and drone heading depending on the drone traffic patterns corresponding to an underlying map; and (2) determining areas where drones are reducing their speed greater than a threshold, (3) determining areas where drones are increasing or decreasing the altitude greater than a threshold, (4) determining areas where the drone are modifying a heading greater than a threshold. In one example, based on a given change in drone operation, the system 100 may provide one or more instructions to capture images and/or video via one or more sensors of the drones in the areas associated with unexpected changes in drone operation. In this example, the sensor data may be provided for further processing and used to route drones away from the affected area.

Referring to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for determine drone traffic patterns or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for determining drone traffic patterns, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in determining drone traffic patterns according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

In one embodiment, the drone 104 is equipped with logic, hardware, firmware, software, memory, etc. to collect, store, and/or transmit data measurements from their respective sensors continuously, periodically, according to a schedule, on demand, etc. In one embodiment, the logic, hardware, firmware, memory, etc. can be configured to perform all or a portion of the various functions associated with generating a drone volatility index according to the various embodiments described herein. The drone 104 can also include means for transmitting the collected and stored data over, for instance, the communication network 115 to the map platform 101 and/or any other components of the system 100 for determining drone traffic patterns and/or initiating navigational services or other map-based functions based on the drone traffic patterns.

In one embodiment, the drone 104 is an unmanned aerial vehicle (UAV). The UAV may be configured to operate in one or more modes (e.g., an autonomous mode or a semi-autonomous mode). In one example, the UAV may be configured to sense its environment or operate in the air without a need for input from an operator, among others. In another example, the UAV may be controlled by a remote human operator, while some functions are carried out autonomously. Further, the UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another, while the UAV's navigation system autonomously controls more fine-grained navigation decisions, such as the specific route to take between the two locations, specific flight controls to achieve the route and avoid obstacles while navigating the route, and so on. It is envisioned that other examples are also possible. By way of example, a drone can be of various forms. For example, a drone may take the form of a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, and/or an ornithopter, among other possibilities.

In one embodiment, drones can be associated other vehicles (e.g., connected and/or autonomous cars). These other vehicles equipped with various sensors can act as probes traveling over a road network within a geographical area represented in the geographic database 107. Accordingly, the drone volatility indices generated from data sensed from locations along the road network can be associated with different areas (e.g., map tiles, geographical boundaries, etc.) and/or other features (e.g., road links, nodes (intersections), POIs) represented in the geographic database 107. Although the vehicles are often described herein as automobiles, it is contemplated that the vehicles can be any type of vehicle, manned or unmanned (e.g., planes, aerial drone, boats, etc.). In one embodiment, the drone 104 is assigned a unique identifier for use in reporting or transmitting data and/or related probe data (e.g., location data).

In one embodiment, the vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. In another example, the vehicle 105 may be an autonomous vehicle. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input).

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for determining drone traffic patterns. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with determining drone traffic patterns, either alone or in combination with the data analysis system 103.

In some embodiments, the UE 109, the drone 104, and/or the vehicle 105 may include various sensors for acquiring a variety of different data or information. For instance, the UE 109, the drone 104, and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109, the drone 104, and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109, the drone 104, and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109, the drone 104, and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109, the drone 104, and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6, and layer 7) headers as defined by the OSI Reference Model.

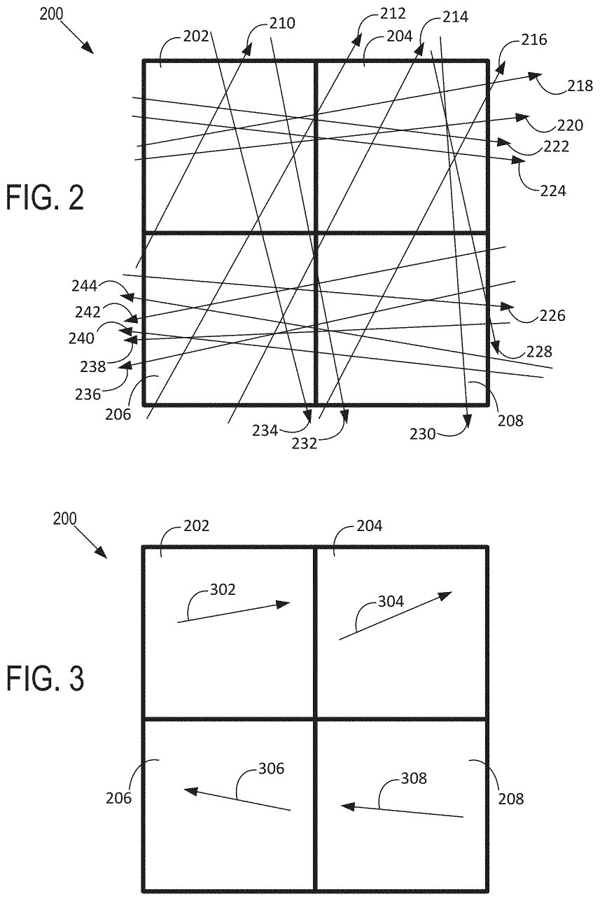

FIG. 2 is a diagram illustrating an example of drone activity in an area. As shown, an area 200 is divided into tiles 202, 204, 206, and 208. In one example, the area 200 represents a geographic area. As shown in FIG. 2, the drone activity in the area 200 is represented by the flight paths 210, 212, 214, 216, 218, 220, 222, 224, 226, 228, 230, 232, 234, 236, 238, 240, 242, and 244 of one or more drones (not shown). In this example, the system 100 can receive drone activity data in the area 200 that is represented by the flight paths 210-244. As shown in FIG. 2, the flight paths 210-244 correspond to one or more of the tiles 202, 204, 206, 208. For example, the drone activity within tile 202 corresponds to the flight paths 210, 212, 218, 220, 222, 224, 232, and 234 and the drone activity within tile 208 corresponds to the flight paths 216, 226, 228, 230, 232, 236, 238, 240, 242, and 244. In one embodiment, the heading of each of the flight paths 210-244 is analyzed by the system 100 to determine one or more drone traffic patterns.

FIG. 3 is a diagram illustrating an example of drone traffic patterns in the area 200 of FIG. 2. In one example, referring to FIG. 3, the system 100 can determine drone traffic patterns based on the average heading of the flight paths in the area 200. In one example, the system 100 can determine a drone traffic pattern 302 based on an average heading of drones that travelled within tile 202 according to the flight paths 210, 212, 218, 220, 222, 224, 232, and 234. In another example, the system 100 can determine a drone traffic pattern 304 based on an average heading of drones that travelled within tile 204 according to the flight paths 212, 214, 216, 218, 220, 222, 224, 228, and 230. In one example, the system 100 can determine a drone traffic pattern 306 based on an average heading of drones that travelled within tile 206 according to the flight paths 210, 212, 214, 226, 232, 234, 236, 238, 240, 242, and 244. In another example, the system 100 can determine a drone traffic pattern 308 based on an average heading of drones that travelled within tile 208 according to the flight paths 216, 226, 228, 230, 232, 236, 238, 240, 242, and 244.

In one embodiment, the system 100 is configured to encode the determined drone traffic patterns 302, 304, 306, and 308 in a database (e.g., geographic database 107 of FIG. 1) to provide one or more instructions for operation of a drone in the area 200. In one embodiment, the system 100 may provide routing instructions to a drone that is expected to travel within the area 200 of FIG. 2. In one example, if a drone is expected to travel along a heading from east to west, then the system 100 may provide routing instructions to the drone to travel within the area represented by tiles 206 and 208 of FIG. 2. In this example, the heading of the drone will more likely align with the average heading of the drones in those tiles based on the drone traffic patterns 306 and 308 of FIG. 3 and therefore the drone will be less likely to collide with other drones travelling in tiles 206 and 208 as opposed to drones travelling in tiles 202 and 204. In another example, if a drone is expected to travel along a heading from west to east, then the system 100 may provide routing instructions to the drone to travel within the area represented by tiles 202 and 204 of FIG. 2. In this example, the heading of the drone will more likely align with the average heading of the drones in those tiles based on the drone traffic patterns 302 and 304 of FIG. 3 and therefore the drone will be less likely to collide with other drones traveling in tiles 202 and 204 as opposed to drones traveling in tiles 206 and 208.

In one embodiment, the drone activity of drones in an area can be collected from any specified period of time. For example, if seasonal variations are to be captured, then the drone activity data should at least cover one year. However, if seasonal variations are to be determined, the drone activity data can be segmented according to seasons so that separate drone traffic patterns can be computed for each season. It is noted that the drone activity can be captured with respect to any contextual parameter as long as the drone activity is segmented according to that contextual parameter. For example, the drone activity can be segmented into days of the week in order to determine drone traffic patterns for each day of the week.

In one embodiment, the system 100 of FIG. 1 may be configured to generate user interface data useable for rendering the determined drone traffic patterns 302, 304, 306, and 308 of FIG. 3 on a user interface. For example, the user interface may include a geographic map and include a two-dimensional cross-section of data corresponding to the drone traffic patterns. The user interface may include various filters that allow a user to view a subset of the available drone traffic patterns. The user interface may be interactive to allow the user to select one or more drone traffic patterns, which causes the user interface to display various attributes for each of the selected drone traffic patterns. In one example, if the drone traffic pattern is determined to be above a threshold, then the visual characteristics of one or more regions of the drone traffic patterns may be associated with the color red. In this example, other regions adjacent to the one or more regions that are not associated with being above the threshold may comprise a visual characteristic associated with the color green. Other examples are possible as well.

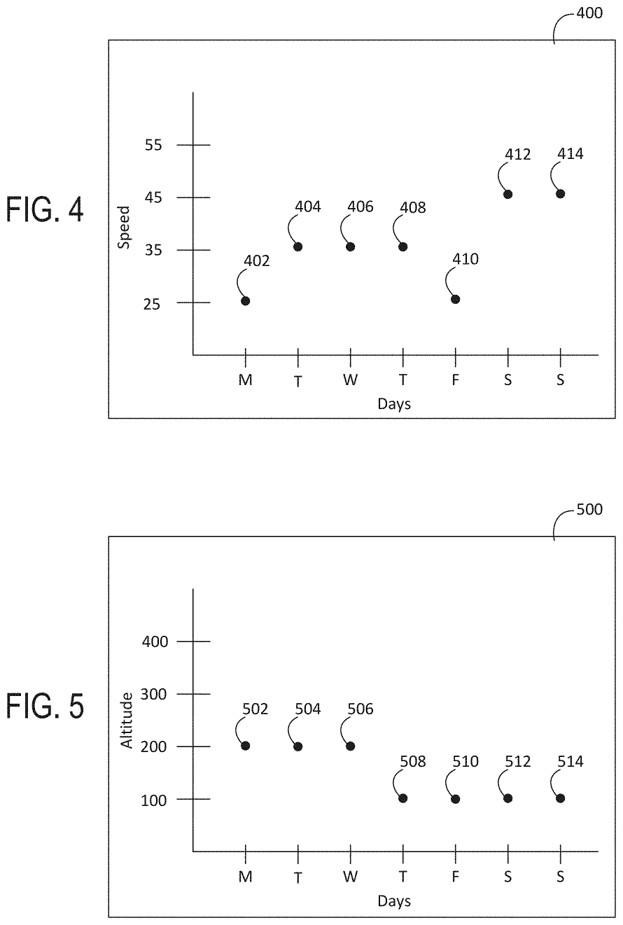

FIG. 4 is a graph 400 illustrating an example of drone traffic patterns. In one example, referring to FIG. 4, the system 100 can analyze drone activity of drones in an area for each day of the week and determine drone traffic patterns based on the average speed of the drones in the area for each day of the week. For example, the system 100 can determine the drone traffic pattern 402 based on average speed of 25 miles per hour (mph) for Monday. Similarly, the system 100 can determine the drone traffic pattern 410 based on an average speed of 25 mph of the drones for Friday. In one example, the system 100 can determine the drone traffic patterns 404, 406, and 408 based on average speed of 35 mph of the drones for Tuesday through Thursday. In another example, the system 100 can determine the drone traffic patterns 412 and 414 based on an average speed of 45 mph of the drones for Saturday and Sunday. It is envisioned that the analysis of the drone activity can also include other attributes besides the average speed of the drone as shown in FIG. 4. In one example, the drone traffic pattern may be based on the function (e.g., delivering a package, monitoring a location, etc.) of the drone in an area in a time period. It is also envisioned that the time slots can be other time periods and not limited to days of the week as shown in FIG. 4. In one example, the time slots can be hours in a day.

In one embodiment, the system 100 may be configured to encode the determined drone traffic patterns 402-414 in a database (e.g., geographic database 107 of FIG. 1) to provide one or more instructions for operation of a drone in the area corresponding to the determined drone traffic patterns 402-414. In one example, if a drone is enroute to a destination and travelling 35 MPH on a Friday and is expected to travel through an area with a determined drone traffic pattern 410 based on an average speed of 25 mph, then the drone may receive an instruction to decrease the speed by 10 mph in order to travel through the area a speed of 25 mph. In another example, if that same drone is enroute to a destination and travelling at 35 mph on a Saturday and is expected to travel through an area with a determined drone traffic pattern 412 based on an average speed of 45 mph, then the drone may receive an instruction to increase the speed by 10 mph in order to match the average speed of 45 mph. In another example, if a drone is unable to modify the speed of travel according to a given drone traffic pattern in a given area, then the drone may receive an instruction to travel through a different area or at different altitude in order to avoid any issues related to travelling through the given area at a slower speed than the average speed.

In one embodiment, the system 100 may be configured to determine a schedule of drone operation based on the one or more drone traffic patterns. For example, the system 100 may be configured to determine a schedule of drone operation based on the drone traffic patterns 402-414. In one example, the system 100 may be configured to determine that one or more drones are more effective when travelling at a speed of 25 mph and therefore best utilized during Mondays and Fridays according to the drone traffic patterns 402 and 410. In this example, the system 100 may also be configured to determine that one or more drones are more effective when travelling at a speed of 35 mph and therefore best utilized on Tuesdays through Thursdays according to the drone traffic patterns 404, 406, and 408. Continuing with this example, the system 100 may also be configured to determine that one or more drones are more effective when travelling at a speed of 45 mph and therefore best utilized on Saturdays and Sundays according to the drone traffic patterns 412 and 414.

FIG. 5 is a graph 500 illustrating another example of drone traffic patterns. In one example, referring to FIG. 5, the system 100 can analyze drone activity of drones in an area for each day of the week and determine drone traffic patterns based on the average altitude of the drones in the area for each day of the week. For example, the system 100 can determine the drone traffic pattern 502 based on average altitude of 200 feet for Monday. Similarly, the system 100 can determine the drone traffic patterns 504 and 506 based on an average altitude of 200 feet for Tuesday and Wednesday. Further, the system 100 can determine the drone traffic patterns 508, 510, 512, and 514 based on average altitude of 100 feet for Thursday through Sunday. It is envisioned that the analysis of the drone activity can also include other attributes besides the average altitude of the drone as shown in FIG. 5. In one example, the drone traffic pattern may be based on the type (e.g., helicopter, multicopter, etc.) of the drone in an area in a time period. It is also envisioned that the time slots can be other time periods and not limited to days of the week as shown in FIG. 5. In one example, the time slots can be fifteen-minute intervals.

In one embodiment, the system 100 may be configured to encode the determined drone traffic patterns 502-514 in a database (e.g., geographic database 107 of FIG. 1) to provide one or more instructions for utilization of the determined drone traffic patterns 502-514. In one embodiment, the system 100 may be configured to determine a change in one or more aspects of drone operation based on the determined drone traffic patterns 502-514 and provide a notification of the change in the one or more aspects of drone operation. In one example, the system 100 may determine that the average altitude associated with the operation of one or more drones is 150 feet on a Tuesday. In this example, the system 100 may be configured to determine a change in altitude of 50 feet based on the drone traffic pattern 504 and one or more drones operating at an altitude of 100 feet. Continuing with this example, the system 100 may be configured to provide a notification regarding the change in altitude for further investigation in the area associated with the drone traffic pattern 504. In another example, the system 100 may be configured to provide an instruction to a drone to operate a drone at an altitude of 200 feet based on the drone traffic pattern 514. In this example, the instruction to operate at a higher altitude than the average altitude of 100 feet may ensure that a drone avoids certain drone activity at an altitude of 100 feet. In one example, system 100 may utilize the drone traffic patterns 502-514 as inputs for determining a maximum height for ascending to in a given area. For example, the system 100 may utilize the drone traffic patterns 506 and 508 and provide instructions for limiting the altitude of operation of a drone to less than 200 feet on Wednesday and less than 100 feet on Thursday. In this example, a drone limited to various altitudes on certain days may be less likely to collide with other drones that are more likely to be travelling at altitudes according to the drone traffic patterns 506 and 508.

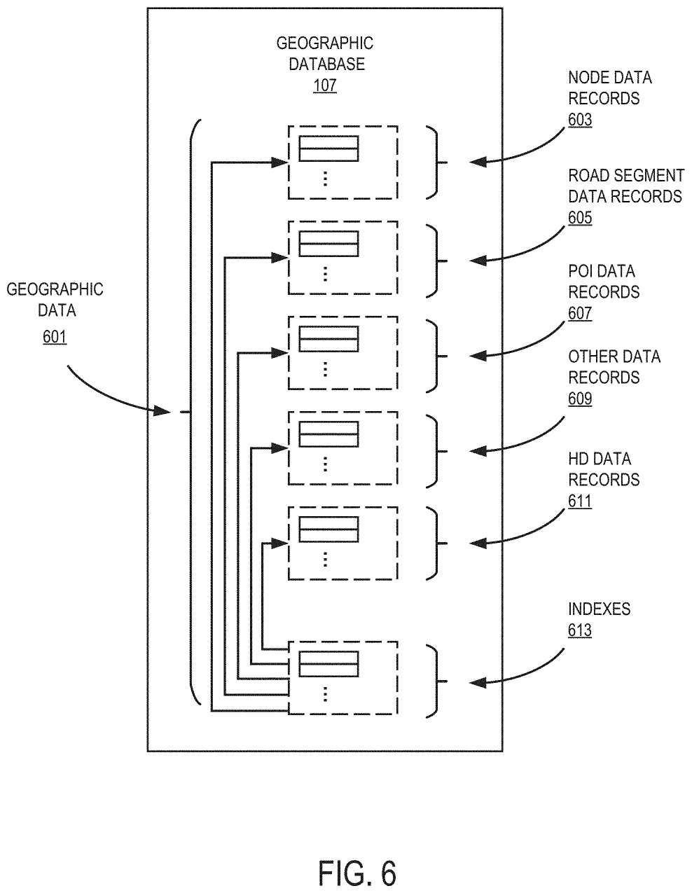

FIG. 6 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 601 used for (or configured to be compiled to be used for) mapping and/or navigation-related services, such as for personalized route determination, according to exemplary embodiments. For example, the geographic database 107 includes node data records 603, road segment data records 605, POI data records 607, other data records 609, HD data records 611, and indexes 613, for example. It is envisioned that more, fewer or different data records can be provided.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 605 are links or segments representing roads, streets, or paths, as can be used in the calculated route or recorded route information for determination of one or more personalized routes, according to exemplary embodiments. The node data records 603 are end points or vertices (such as intersections) corresponding to the respective links or segments of the road segment data records 605. The road segment data records 605 and the node data records 603 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 607. In one example, the POI data records 607 may include the hours of operation for various businesses. The geographic database 107 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, other data records 609 include cartographic (“carto”) data records, routing data, drone traffic pattern data, weather data, and maneuver data. In one example, the other data records 609 include data that is associated with certain POIs, roads, or geographic areas. In one example, the data is stored for utilization by a third-party. In one embodiment, the other data records 609 include weather data records such as weather data reports. In another embodiment, the other data records 609 include drone traffic pattern data records. In one example, the drone traffic pattern data records may be based on an average speed of drones in a geographic area. In another example, the drone traffic pattern data records may be based on an average altitude of drones in a geographic area. In another example, the drone traffic pattern data records may be based on an average heading of drones in a geographic area. For example, the weather data records can be associated with any of the map features stored in the geographic database 107 (e.g., a specific road or link, node, intersection, area, POI, etc.) on which the weather data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, the geographic database 107 may also include point data records for storing the point data, map features, as well as other related data used according to the various embodiments described herein. In addition, the point data records can also store ground truth training and evaluation data, machine learning models, annotated observations, and/or any other data. By way of example, the point data records can be associated with one or more of the node data records 603, road segment data records 605, and/or POI data records 607 to support verification, localization or visual odometry based on the features stored therein and the corresponding estimated quality of the features. In this way, the point data records can also be associated with or used to classify the characteristics or metadata of the corresponding records 603, 605, and/or 607.

As discussed above, the HD data records 611 may include models of road surfaces and other map features to centimeter-level or better accuracy. The HD data records 611 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 611 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 611 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 611.

In one embodiment, the HD data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The indexes 613 in FIG. 6 may be used improve the speed of data retrieval operations in the geographic database 107. Specifically, the indexes 613 may be used to quickly locate data without having to search every row in the geographic database 107 every time it is accessed. For example, in one embodiment, the indexes 613 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

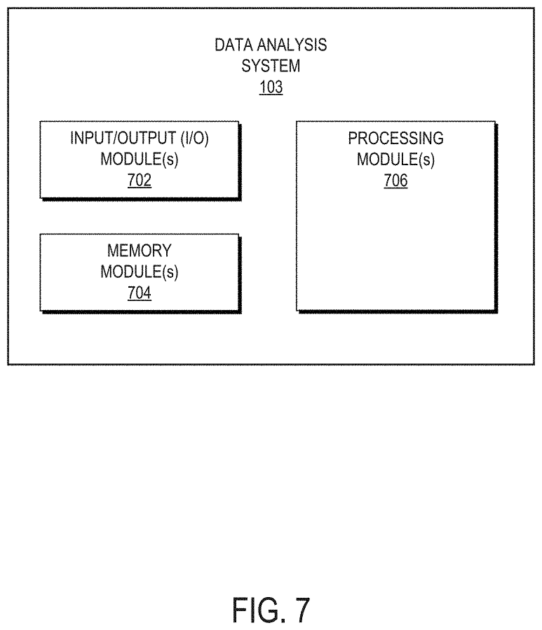

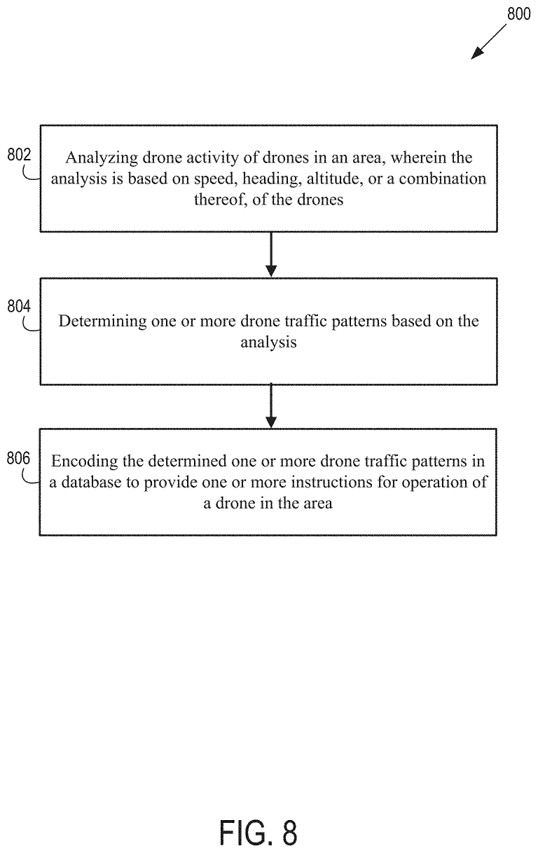

FIG. 7 is a diagram of the components of the data analysis system 103 of FIG. 1, according to one embodiment. By way of example, the data analysis system 103 includes one or more components for determining drone traffic patterns according to the various embodiments described herein. It is contemplated that the functions of these components may be combined or performed by other components of equivalent functionality. In this embodiment, data analysis system 103 includes in input/output module 702, a memory module 704, and a processing module 706. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 702-706 may be implemented as a cloud-based service, local service, native application, or combination thereof. The functions of these modules are discussed with respect to FIGS. 8, 9, and 10 below.

FIGS. 8, 9, and 10 are flowcharts of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 8, 9, and 10 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 8, 9, and 10 may represent circuitry that is wired to perform the specific logical functions in the process. Illustrative methods, such as those shown in FIGS. 8, 9, and 10, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 8, 9, and 10 may be fully performed by a computing device (or components of a computing device such as one or more processors) or may be distributed across multiple components of the computing device, across multiple computing devices, and/or across a server.

Referring first to FIG. 8, an example method 800 may include one or more operations, functions, or actions as illustrated by blocks 802-806. The blocks 802-806 may be repeated periodically or performed intermittently, or as prompted by a user, device, or system. In one embodiment, the method 800 is implemented in whole or in part by the data analysis system 103 of FIG. 7.

As shown by block 802, the method 800 includes analyzing drone activity of drones in an area, wherein the analysis is based on speed, heading, altitude, or a combination thereof, of the drones. In one example, the input/output module 702 of FIG. 7 is configured to receive drone activity data of the drones in the area. In one example, the area is a tile, a sub-tile, a road segment, a node, an air path, or portion thereof. In another example, the area is one or more geographical boundaries. In one example, the area includes a specific road, link, node, intersection, POI, or a combination thereof. Continuing with this example, the processing module 706 of FIG. 7 is configured to receive the drone activity from the input/output module 702 and analyze the drone activity of the drones in the area. The analysis is based on a speed, heading, and altitude, or a combination thereof, of the drones.

As shown by block 804, the method 800 also includes determining one or more drone traffic patterns based on the analysis. In one example, the processing module 706 of FIG. 7 is configured to determine one or more drone traffic patterns based on the analysis. In one embodiment, the method 800 may further include determining a drone traffic pattern based on the average speed of the drones in the area. In another embodiment, the method 800 may further include determining a drone traffic pattern based on the average heading of the drones in the area. In one embodiment, the method 800 may further include determining the one or more drone traffic patterns based on the analysis comprises determining a drone traffic pattern based on the average altitude of the drones in the area. In another embodiment, the method 800 may further include determining the one or more drone traffic patterns based on an average speed of the drones in the area, an average heading of the drones in the area, and an average altitude of the drones in the area, or a combination thereof.

As shown by block 806, the method 800 also includes encoding the determined one or more drone traffic patterns in a database to provide one or more instructions for operation of a drone in the area. In one example, the one or more instructions include an instruction for performing a navigation function of the drone. In another example, the one or more instructions include an instruction for modifying one or more aspects (e.g., speed, heading, altitude, etc.) of the operation of the drone. In one example, the one or more instructions may include an instruction for activating one more sensors (e.g., image sensors, audio sensors, etc.) for monitoring the area.

In one embodiment, the method 800 also includes mapping the determined one or more drone traffic patterns onto one or more map data layers of a high-definition map to provide the one or more instructions for operation of the drone in the area. In one example, one or more drone traffic patterns for a first type (e.g., multicopter) of drones can be stored in a first map data layer and one or more drone traffic patterns for a second type (e.g., helicopter) of drones can be stored in a second map data layer. In another example, one or more drone traffic patterns for a first location can be stored in a first map data layer and one or more drone traffic patterns for a second location can be stored in a second map data layer. In one example, one or more drone traffic patterns for a first time or date can be stored in a first map data layer and one or more drone traffic patterns for a second time or date can be stored in a second map data layer. In one embodiment, the method 800 also includes linking the one or more drone traffic patterns with one or more portions, components, areas, layers, features, text, symbols, and/or data records of a map (e.g., an HD map).

In one embodiment, the method 800 may further include determining a first drone traffic pattern based on the average altitude of the drones in the area and determining a second drone traffic pattern based on the average heading of the drones in the area. In this embodiment, the method 800 may further include determining a flight path of the drones according to the first drone traffic pattern and the second drone traffic pattern. In one embodiment, the method 800 may further include determining a first drone traffic pattern based on the average altitude of the drones in the area, determining a second drone traffic pattern based on the average heading of the drones in the area, and determining a third drone traffic pattern based on the average speed of the drones in the area. In this embodiment, the method 800 may further including determining a flight path of the drones according to the first drone traffic pattern, the second drone traffic pattern, and the third drone traffic pattern. In one example, the determined flight path may be used to determine whether drones are ascending or descending in one or more areas. In another example, the determined flight path may be used to determine whether drones are used being utilized for delivering packages or for monitoring an area.

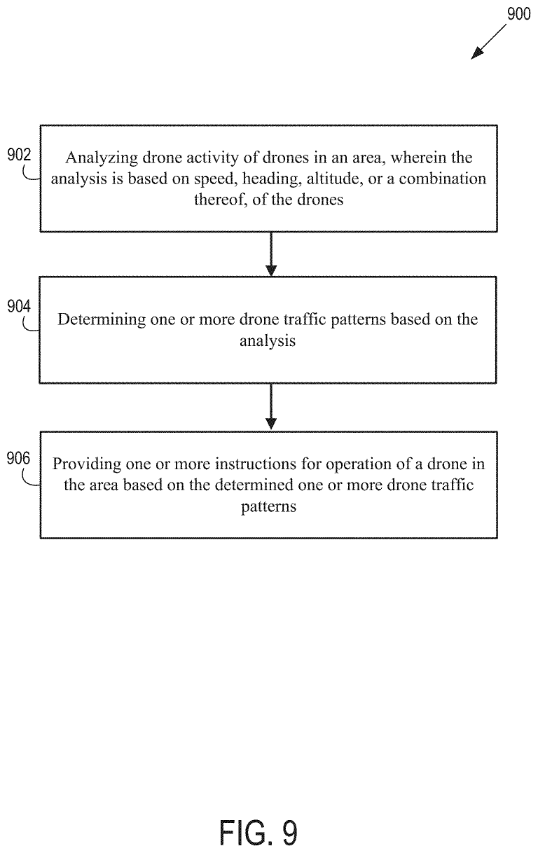

Referring to FIG. 9, the example method 900 may include one or more operations, functions, or actions as illustrated by blocks 902-906. The blocks 902-906 may be repeated periodically or performed intermittently, or as prompted by a user, device, or system. In one embodiment, the method 900 is implemented in whole or in part by the data analysis system 103 of FIG. 7.

As shown by block 902, the method 900 includes analyzing drone activity of drones in an area, wherein the analysis is based on speed, heading, altitude, or a combination thereof, of the drones. Block 902 may be similar in functionality to block 802 of method 800.

As shown by block 904, the method 900 also includes determining one or more drone traffic patterns based on the analysis. In one example, the processing module 706 of FIG. 7 is configured to determine at one or more drone traffic patterns based on the analysis. In one embodiment, the method 900 may further include determining a drone traffic pattern based on the average speed of the drones in the area. In this embodiment, the method 900 may further include providing an instruction for modifying a speed of the drone according to the drone traffic pattern based on the average speed of the drones in the area. In one example, the instruction for modifying the speed of the drone may include an instruction for operating the drone according to the average speed of the drones in the area. In another example, the instruction for modifying the speed of the drone may include an instruction for going faster or slower than the average speed of the drones in the area.

In one embodiment, the method 900 may further include determining a drone traffic pattern based on the average heading of the drones in the area. In this embodiment, the method 900 may further include providing an instruction for modifying a heading of the drone according to the drone traffic pattern based on the average heading of the drones in the area. In one example, the instruction for modifying the heading of the drone may include an instruction for matching the heading of the average heading of the drones in the area. In one embodiment, the method 900 may further include determining a drone traffic pattern based on the average altitude of the drones in the area. In this embodiment, the method 900 may further include providing an instruction for modifying an altitude of the drone according to the drone traffic pattern based on the average altitude of the drones in the area. In one example, the instruction for modifying the altitude of the drone may include an instruction for operating the drone at the average altitude of the drones in the area. In another example, the instruction for modifying the altitude of the drone may include an instruction for operating the drone at an altitude that is above or below the average altitude of the drones in the area.

As shown by block 906, the method 900 also includes providing one or more instructions for utilization of the determined one or more drone traffic patterns. In one example, the processing module 706 of FIG. 7 is configured to provide one or more instructions for utilization of the determined one or more drone traffic patterns via the input/output module 702 of FIG. 7. In one example, the utilization of the determined one or more drone traffic patterns may include an instruction for routing purposes. In one example, the instruction for utilization may include an instruction for updating the drone traffic patterns in one or more areas based on a determined priority for the one or more areas. For example, if the average speed of drones in an area is above a predetermined threshold, then the drone traffic pattern based on the average speed for that area will be determined in shorter intervals.

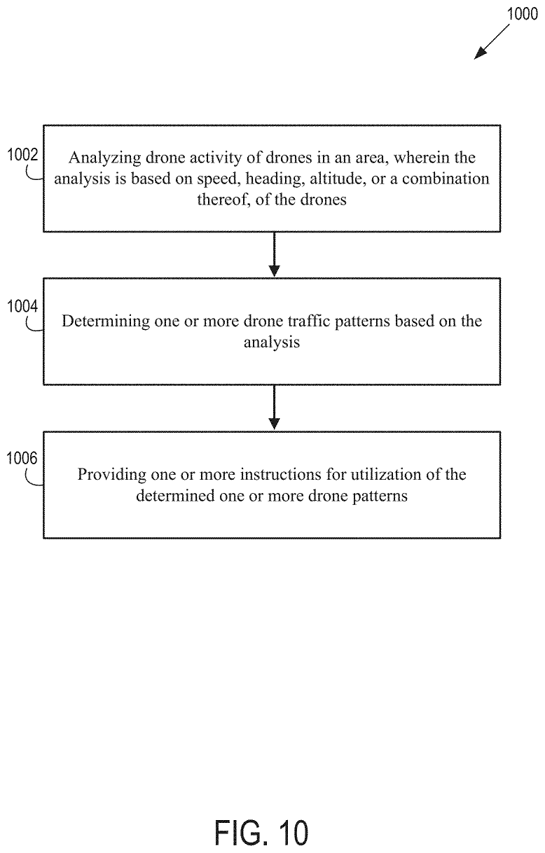

Referring to FIG. 10, the example method 1000 may include one or more operations, functions, or actions as illustrated by blocks 1002-1006. The blocks 1002-1006 may be repeated periodically or performed intermittently, or as prompted by a user, device, or system. In one embodiment, the method 900 is implemented in whole or in part by the data analysis system 103 of FIG. 7.

As shown by block 1002, the method 1000 includes analyzing drone activity of drones in an area, wherein the analysis is based on speed, heading, altitude, or a combination thereof, of the drones. Block 1002 may be similar in functionality to block 802 of method 800.

As shown by block 1004, the method 1000 also includes determining one or more drone traffic patterns based on the analysis. In one example, the processing module 706 of FIG. 7 is configured to determine at one or more drone traffic patterns based on the analysis. In one embodiment, the method 1000 further includes determining a drone traffic pattern based on the average speed of the drones in the area. In another embodiment, the method 1000 further includes determining a drone traffic pattern based on the average altitude of the drones in the area. In one embodiment, the method 1000 further includes determining a drone traffic pattern based on the average heading of the drones in the area.

As shown by block 1006, the method 1000 also includes providing one or more instructions for utilization of the determined one or more drone traffic patterns. In one example, the processing module 706 of FIG. 7 is configured to provide one or more instructions for utilization of the determined one or more drone traffic patterns via the input/output module 702 of FIG. 7. In one embodiment, the method 1000 further includes determining a modification in one or more aspects of drone operation. In this embodiment, the method 1000 further includes comparing the modification in one ore mores aspects of drone operation to one or more drone traffic patterns. Continuing with this embodiment, the method 1000 further includes based on the comparison, providing a notification of the change in the one or more aspects of the drone operation. For example, if a drone traveling at a speed of 45 mph in an area associated with a drone traffic pattern based on an average speed of 45 mph experiences a slowdown of 25 mph, then a notification to avoid the area could be sent to other drones that may be approaching the area. It is envisioned that similar notifications could be provided based on unexpected changes in heading and altitude. In another embodiment, the method 1000 further includes determining a schedule of drone operation based on the one or more drone traffic patterns. In one example, the schedule of drone operation may be determined by comparing the capabilities of various drones to the one or more drone traffic patterns.

The processes described herein for determining drone traffic patterns may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

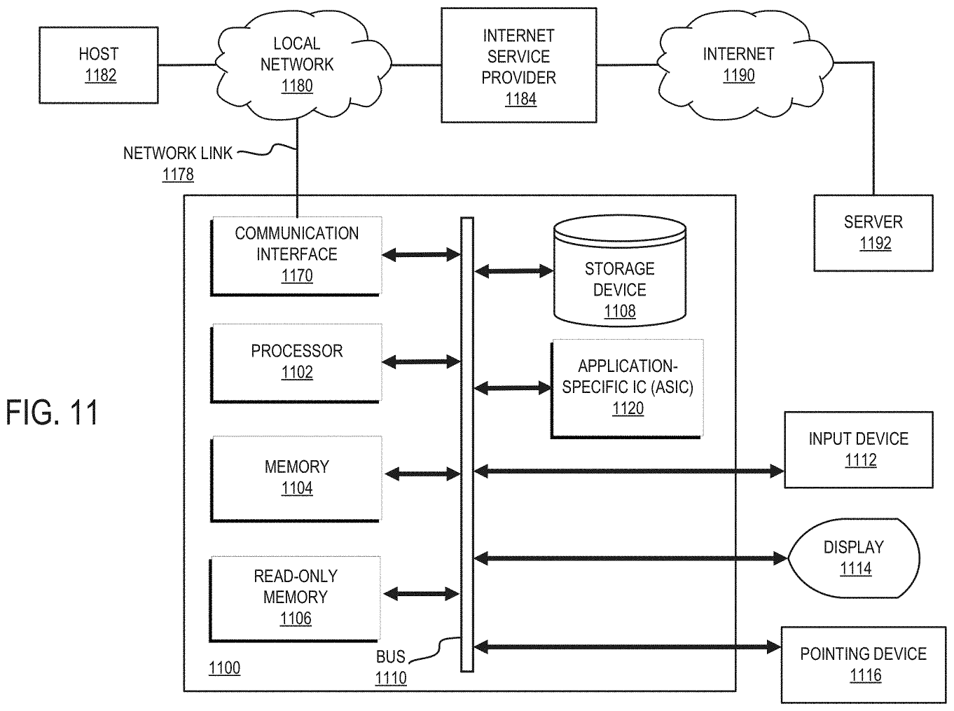

FIG. 11 illustrates a computer system 1100 upon which an embodiment may be implemented. Computer system 1100 is programmed (e.g., via computer program code or instructions) to provide information for determining drone traffic patterns as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to determining drone traffic patterns. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random-access memory (RAM) or other dynamic storage device, stores information including processor instructions for determining drone traffic patterns. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for determining drone traffic patterns, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in the computer system 1100. Other external devices coupled to bus 1110, used primarily for interacting with humans, include a display 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1100 may also include one or more instances of a communications interface 1170 coupled to bus 1110. The communication interface 1170 may provide a one-way or two-way communication coupling to a variety of external devices that operate with their own processors, such as printers, scanners and external disks. In addition, the communication interface 1170 may provide a coupling to a local network 1180, by way of a network link 1178. The local network 1180 may provide access to a variety of external devices and systems, each having their own processors and other hardware. For example, the local network 1180 may provide access to a host 1182, or an internet service provider 1184, or both, as shown in FIG. 11. The internet service provider 1184 may then provide access to the Internet 1190, in communication with various other servers 1192.

The computer system 1100 also includes one or more instances of a communication interface 1170 coupled to bus 1110. Communication interface 1170 provides a one-way or two-way communication coupling to a variety of external devices that operate with their own processors, such as printers, scanners and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, the communication interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, the communication interface 1170 may be a local area network (LAN) card to provide a data communication connection to a compatible LAN, such as Ethernet. Wireless links may also be implemented. For wireless links, the communication interface 1170 sends or receives or both sends and receives electrical, acoustic or electromagnetic signals, including infrared and optical signals, that carry information streams, such as digital data. For example, in wireless handheld devices, such as mobile telephones like cell phones, the communication interface 1170 includes a radio band electromagnetic transmitter and receiver called a radio transceiver. In certain embodiments, the communication interface 670 enables connection to the communication network 115 of FIG. 1 for providing information for determining drone traffic patterns.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

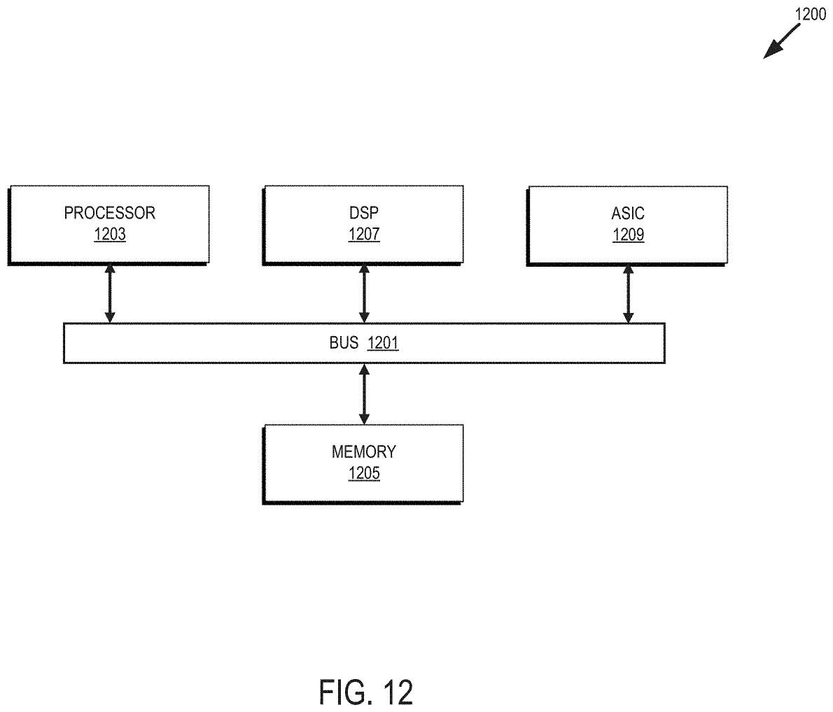

FIG. 12 illustrates a chip set 1200 upon which an embodiment may be implemented. The chip set 1200 is programmed to determine drone traffic patterns as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the steps described herein to provide information for determining drone traffic patterns. The memory 1205 also stores the data associated with or generated by the execution of the inventive steps.

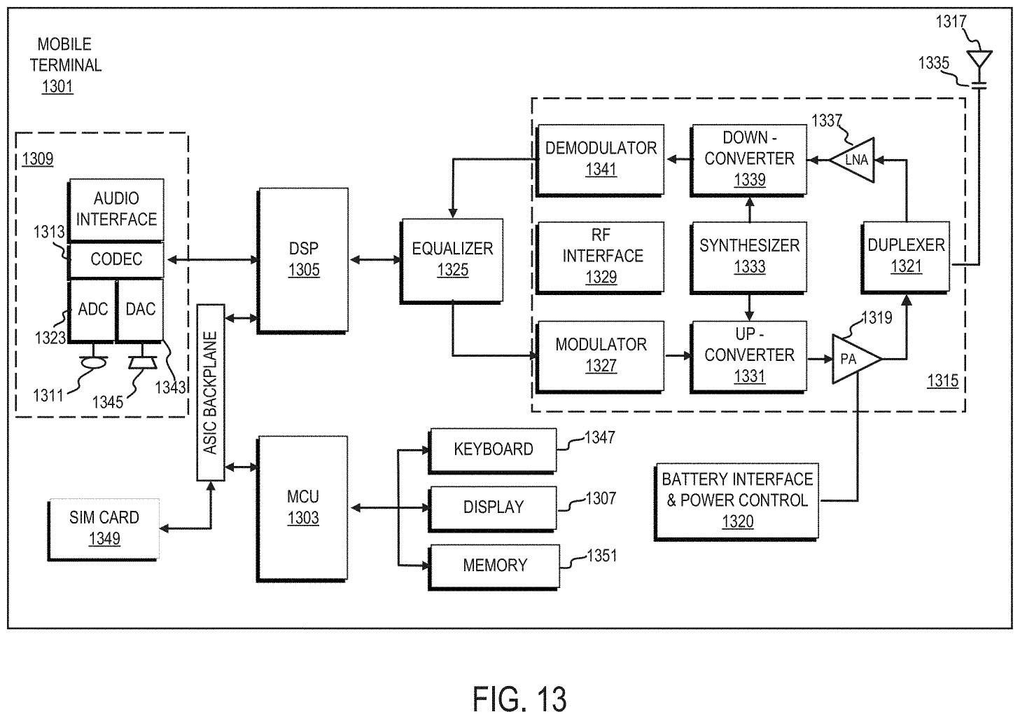

FIG. 13 is a diagram of exemplary components of a mobile terminal 1301 (e.g., a mobile device, vehicle, drone, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide information for determining drone traffic patterns. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We (I) claim:

1. A method for determining a drone traffic pattern, the method comprising:
analyzing drone activity of drones in an area, wherein the analysis is based on speed, heading, altitude, or a combination thereof, of the drones;
determining one or more drone traffic patterns based on the analysis; and
encoding the determined one or more drone traffic patterns in a database to provide one or more instructions for operation of a drone in the area.

2. The method of claim 1, wherein encoding the determined one or more drone traffic patterns comprises mapping the determined one or more drone traffic patterns onto a map data layer of a high-definition map to provide the one or more instructions for operation of the drone in the area.

3. The method of claim 1, wherein determining the one or more drone traffic patterns based on the analysis comprises determining a drone traffic pattern based on the average speed of the drones in the area.

4. The method of claim 1, wherein determining the one or more drone traffic patterns based on the analysis comprises determining a drone traffic pattern based on the average heading of the drones in the area.

5. The method of claim 1, wherein determining the one or more drone traffic patterns based on the analysis comprises determining a drone traffic pattern based on the average altitude of the drones in the area.

6. The method of claim 1, wherein determining the one or more drone traffic patterns based on the analysis comprises determining a first drone traffic pattern based on the average altitude of the drones in the area and determining a second drone traffic pattern based on the average heading of the drones in the area, the method further comprising:
determining a flight path of the drones according to the first drone traffic pattern and the second drone traffic pattern.

7. The method of claim 1, wherein determining the one or more drone traffic patterns based on the analysis comprises determining a first drone traffic pattern based on the average altitude of the drones in the area, determining a second drone traffic pattern based on the average heading of the drones in the area, and determining a third drone traffic pattern based on the average speed of the drones in the area, the method further comprising:
determining a flight path of the drones according to the first drone traffic pattern, the second drone traffic pattern, and the third drone traffic pattern.

8. A non-transitory computer-readable storage medium comprising one or more sequences of one or more instructions for execution by one or more processors of a device, the one or more instructions which, when executed by the one or more processors, cause the device to:
analyze drone activity of drones in an area, wherein the analysis is based on speed, heading, altitude, or a combination thereof, of the drones;
determine one or more drone traffic patterns based on the analysis; and
provide one or more instructions for operation of a drone in the area based on the determined one or more drone traffic patterns.

9. The non-transitory computer-readable storage medium of claim 8, wherein the one or more instructions which, when executed by the one or more processors, cause the device to determine the one or more drone traffic patterns based on the analysis further cause the device to determine a drone traffic pattern based on the average speed of the drones in the area.

10. The non-transitory computer-readable storage medium of claim 9, wherein the one or more instructions which, when executed by the one or more processors, cause the device to provide the one or more instructions for operation of the drone in the area based on the determined one or more drone traffic patterns further cause the device to provide an instruction for modifying a speed of the drone according to the drone traffic pattern based on the average speed of the drones in the area.

11. The non-transitory computer-readable storage medium of claim 8, wherein the one or more instructions which, when executed by the one or more processors, cause the device to determine the one or more drone traffic patterns based on the analysis further cause the device to determine a drone traffic pattern based on the average heading of the drones in the area.

12. The non-transitory computer-readable storage medium of claim 11, wherein the one or more instructions which, when executed by the one or more processors, cause the device to provide the one or more instructions for operation of the drone in the area based on the determined one or more drone traffic patterns further cause the device to provide an instruction for modifying a heading of the drone according to the drone traffic pattern based on the average heading of the drones in the area.

13. The non-transitory computer-readable storage medium of claim 8, wherein the one or more instructions which, when executed by the one or more processors, cause the device to determine the one or more drone traffic patterns based on the analysis further cause the device to determine a drone traffic pattern based on the average altitude of the drones in the area.

14. The non-transitory computer-readable storage medium of claim 13, wherein the one or more instructions which, when executed by the one or more processors, cause the device to provide the one or more instructions for operation of the drone in the area based on the determined one or more drone traffic patterns further cause the device to provide an instruction for modifying an altitude of the drone according to the drone traffic pattern based on the average altitude of the drones in the area.

15. An apparatus comprising:
a processor; and
a memory comprising computer program code for one or more programs, wherein the computer program code is configured to cause the processor of the apparatus to:
analyze drone activity of drones in an area, wherein the analysis is based on speed, heading, altitude, or a combination thereof, of the drones;
determine one or more drone traffic patterns based on the analysis; and
provide one or more instructions for utilization of the determined one or more drone traffic patterns.

16. The apparatus of claim 15, wherein the computer program code is configured to cause the processor of the apparatus to determine one or more drone traffic patterns based on the analysis is further configured to cause the processor of the apparatus to determine a drone traffic pattern based on the average speed of the drones in the area.

17. The apparatus of claim 15, wherein the computer program code is configured to cause the processor of the apparatus to determine one or more drone traffic patterns based on the analysis is further configured to cause the processor of the apparatus to determine a drone traffic pattern based on the average altitude of the drones in the area.

18. The apparatus of claim 15, wherein the computer program code is configured to cause the processor of the apparatus to determine one or more drone traffic patterns based on the analysis is further configured to cause the processor of the apparatus to determine a drone traffic pattern based on the average heading of the drones in the area.

19. The apparatus of claim 15, wherein the computer program code is configured to cause the processor of the apparatus to provide the one or more instructions for utilization of the determined one or more drone patterns is further configured to determine a schedule of drone operation based on the one or more drone traffic patterns.

20. The apparatus of claim 15, wherein the computer program code is configured to cause the processor of the apparatus to provide the one or more instructions for utilization of the determined one or more drone patterns is further configured to:
determine a modification in one or more aspects of drone operation;
compare the modification in the one ore mores aspects of the drone operation to one or more drone traffic patterns; and
based on the comparison, provide a notification of the change in the one or more aspects of the drone operation.
